(19) United States
(12) Patent Application Publication
(10) Pub. No.: US 2005/0174879 A1
(43) Pub. Date: Aug. 11, 2005

(54) Method and apparatus for adjusting a slump in and washing concrete mixing trucks

(75) Inventors: Stuart Bentley, Landisville, PA (US); Kevin J. McCabe, Lockport, NY (US)

Correspondence Address: BURNS DOANE SWECKER & MATHIS L L P, POST OFFICE BOX 1404, ALEXANDRIA, VA, 22313-1404, US

(73) Assignee: LAFARGE NORTH AMERICA

(21) Appl. No.: 10/816,832

(22) Filed: Apr. 5, 2004

Related U.S. Application Data
(63) Continuation of application No. 10/625,607, filed on Jul. 24, 2003, now abandoned.

(51) Int. Cl. B28C 5/06; B28C 5/46; B28C 7/04

(52) U.S. Cl. 366/3; 366/7; 366/10; 366/16; 366/40

(57) ABSTRACT

A system for adjusting a proper slump in a mixing drum of a mixing truck, the system includes a frame having an opening through which the mixing truck can pass; a camera mounted on the frame for viewing the mixing truck; a monitor for monitoring the camera, wherein the monitor is at a location remote from the mixing truck; a water pipe mounted on the frame for depositing water into the mixing truck; and a control panel for controlling the depositing of water into the truck, the control panel being adjacent the monitor. Optionally, the system may include a plurality of nozzles mounted on the frame and arranged for washing an exterior of the mixing truck. The system can be controlled from the remote location.

### CROSS-REFERENCE TO RELATED APPLICATION

The present application is a continuation of U.S. patent application Ser. No. 10/625,607, filed on Jul. 24, 2003, the entire contents of which is hereby incorporated herein by reference.

### BACKGROUND OF THE INVENTION

1. Field of the Invention

The present invention relates to an automated system for adjusting the slump of concrete in a mixing drum of a mixing truck and/or washing the mixing truck.

2. Description of Related Art

Conventionally, the drum of a mixing truck is loaded with the concrete at a plant. After the truck is loaded, the truck moves to a second location, wherein the driver of the truck exits the truck, and manually inspects the contents of the truck to determine if additional water is required in order to bring the concrete to a proper slump or viscosity. In addition, because of the residual dust and unintentional spillage, it is also highly recommended for the driver to hose down the truck in order to prevent cement buildup from setting on the truck. Once the proper amount of water is added to the mixing drum to ensure the proper slump and the truck is cleaned, the driver then leaves the premises and delivers the concrete to the job site.

The conventional system has several disadvantages. First, the process is time consuming. In addition, because the driver is required to leave the truck and walk around in what is a typically wet, slippery area, slips and injury to the driver are not uncommon. Furthermore, the determination of how much water to add to the mixing drum is quite subjective. Accordingly, each driver has his or her own interpretation of the proper amount of water to be added to achieve a proper slump. Accordingly, if several trucks are going to the same job site, the consistency or slump of the delivered concrete may differ between each truck.

### OBJECTS AND SUMMARY

It is an object of the present invention to simplify the truck loading and slump adjusting process.

It is an additional object of the present invention to decrease the amount of time required for washing a truck and adjusting the slump of the concrete therein.

It is yet another object of the present invention to increase the level of safety involved with washing a truck and adjusting the slump of the concrete therein.

### BRIEF DESCRIPTION OF THE DRAWINGS

FIG. 1 is a schematic side view of an embodiment of the system of the present invention.

FIG. 2 is a schematic end view of a portion of an embodiment of the present invention.

FIG. 3 is an illustration of a monitor used in one embodiment of the present invention.

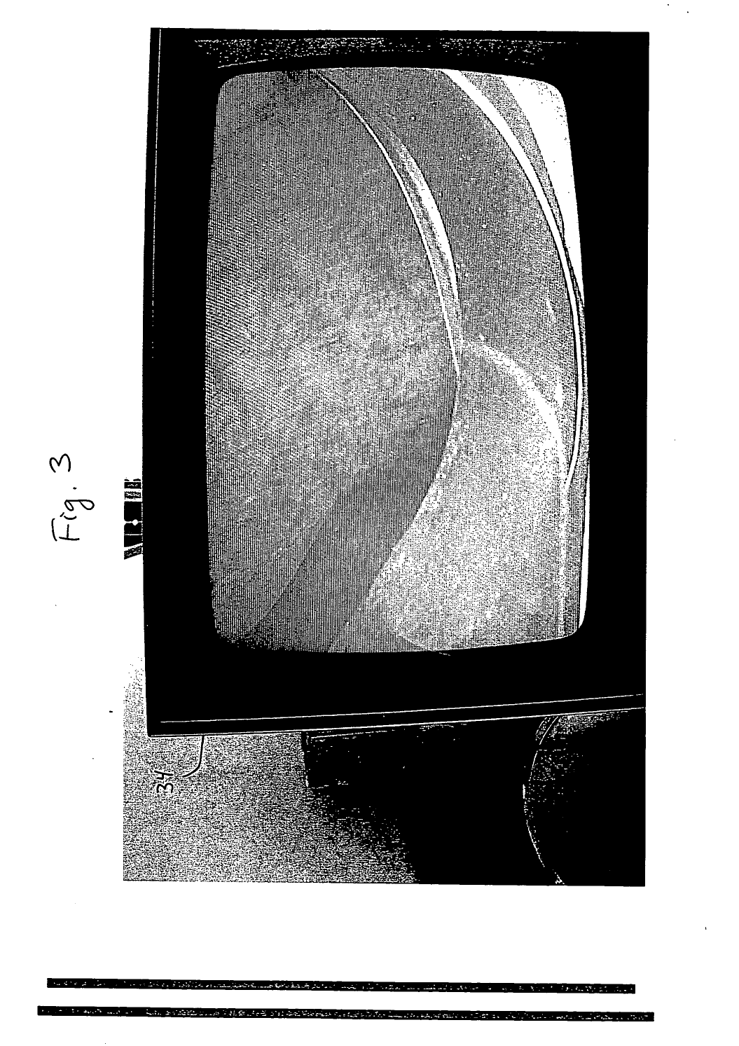

### DETAILED DESCRIPTION OF THE PREFERRED EMBODIMENTS

In one embodiment of the present invention, an automated system is provided for adjusting a slump of the concrete within a mixing drum of a mixing truck. As used herein, the term “driver” refers to the driver of the mixing truck, and the term“operator” refers to a station operator who is located at a position outside of the mixing truck, preferably in a housing provided with a window overlooking the area in which the slump is adjusted. And, the term “remote” means at a location away from the area in which the slump is adjusted. “Remote” does not imply or require any minimum distance. The present invention has application to both wet batch plants and dry batch plants.

A station 14 includes, in a preferred embodiment, a frame comprising two vertical posts 22 and a horizontal beam 24. The station 14 includes station 14 includes a plurality of nozzles 20 mounted on the frame which defines a path or opening through which the truck passes. The station also includes a nozzle 18 for delivering water into the mixing truck and a camera 16 arranged so that the plant operator can monitor the truck 10 with a monitor 32 from a remote location.

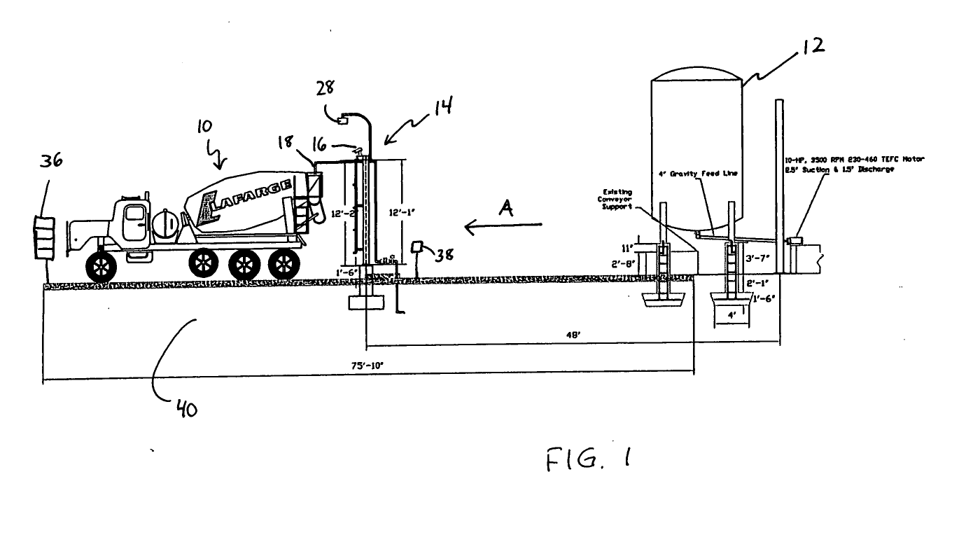

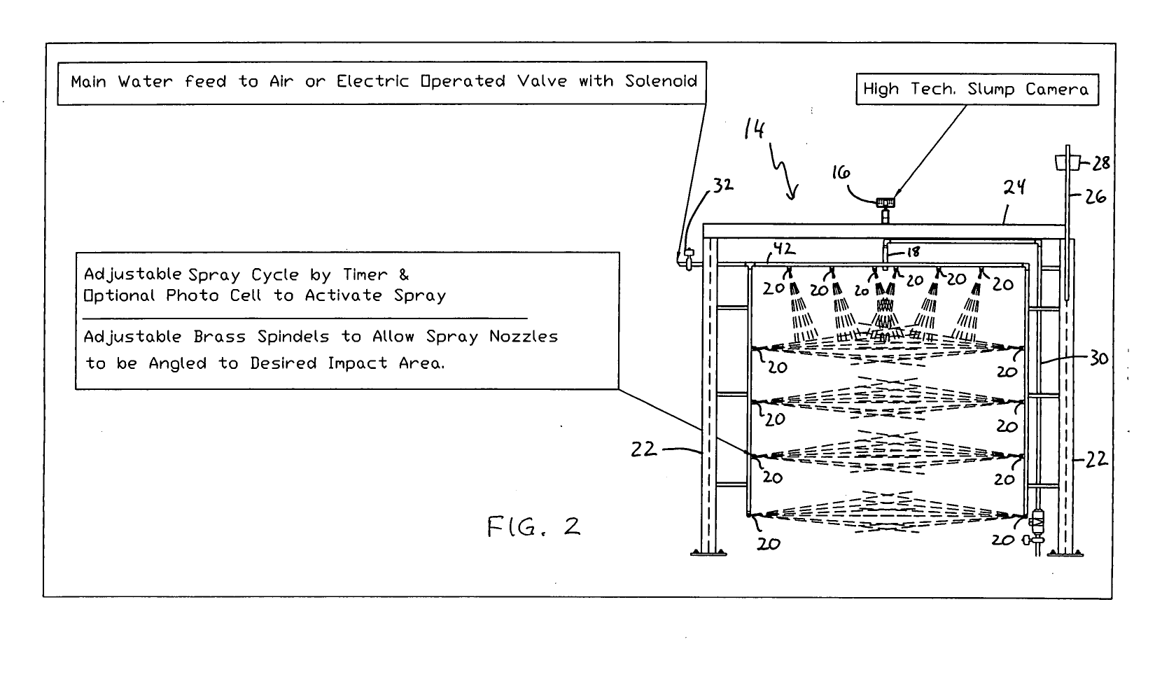

As illustrated in FIG. 1, a mixing truck 10 moves through the system in the direction indicated by arrow A. Prior to the truck 10 entering the system illustrated in FIG. 1, the truck is filled with concrete. As the truck 10 moves in the direction of arrow A past a photo cell 38, a truck washing system is activated. As can be best seen in FIG. 2, after the photo cell 38 is activated, a valve 32 is opened to allow water to be emitted from the nozzles 20 so as to automatically clean the truck 10 as it passes through the station 14.

In an alternative embodiment, instead of using a photocell to turn on the nozzles, a control system can be set up so that the nozzles automatically are turned on at a predetermined amount of time after the mixing truck leaves the concrete loading station. In another alternative embodiment, the nozzles can be turned on by a station operator.

After the driver passes through the frame of the station 14 and arrives at the position illustrated in FIG. 1, the driver is signaled to stop the truck by a signal post 36 which includes a plurality of light signals which provide instructions to the driver. The light signals are controlled by the station operator. The light signals 36 instruct the driver to stop the truck 10 in a position such that the nozzle 18 is positioned over the inlet opening of the truck 10. At the illustrated position, the camera 16 is able to view the interior of the mixing drum of the truck 10 so that the station operator can, from a visual inspection, ascertain the viscosity or slump of the concrete within the truck 10. An optional floodlight 28 may assist the visual inspection with illumination, particularly at night time.

The signal post 36 may have four different signals on it: red—stop; yellow—charge normal speed; blue—discharge normal speed; and green—go.

In an alternative embodiment, a slump gauge may be mounted at the back end of the truck 10, and the camera 16 is used to view the slump gauge, instead of viewing directly into the mixing drum in order to ascertain the viscosity or slump of the concrete inside the truck 10. The slump gauge can be any suitable design, including a commercially available product that determines the slump based on hydraulic pressure.

After the operator views either the contents of the truck 10 with the camera 16 or views a slump gauge mounted on the back of the truck, the operator determines how much water, if any, should be added to the mixing drum of the truck 10 in order to provide the concrete therein with a proper viscosity or slump.

The added water needed to adjust the slump is programmed into a control box, such as a badger meter, and is then automatically delivered to the mixing drum of the truck via the nozzle 18 mounted on the station 14 frame. Alternatively, the operator simply operates a control that turns nozzle 18 on and off in a manual mode.

After the proper amount of water has been added to the mixing drum of the truck 10 via the nozzle 18, the plant operator signals to the truck driver via the light signal 36 that the operation is complete and the driver may leave the premises and deliver the concrete to the appropriate job site.

In one embodiment, the station 14 may also include a fiber rack for holding fiber in a weather-proof container so that fiber may be added to the mixing drum during the slump adjusting process.

In some situations, the water source may not provide enough pressure to enable adequate cleaning of the mixing truck. In that case, a pressurized water tank 12 can be used to maintain a source of pressurized water near the slump adjusting station 14.

One advantage of the present system is that the plant operator is determining the amount of necessary slump water for each of a plurality of trucks which may be going to the same job site. As a result, the concrete in each of the trucks is prepared to a substantially similar slump so that the consistency or quality of the concrete is uniform at the job site.

A further advantage is that the driver of the truck 10 does not need to leave the vehicle during the process. By enabling the driver to stay in the truck 10 during this filling process, safety and speed are increased.

In the preferred illustrated embodiment of the present invention, each of the nozzles 20 is a high intensity V jet nozzle. The nozzles 20 are strategically located and mounted on a 2 inch diameter manifold pipe 42. The pipe 42 is supported by the frame comprising the two vertical posts 22 and the horizontal beam 24. One skilled in the art would recognize that alternative frame designs are possible.

In a preferred embodiment, the camera 16 is a high resolution digital camera 16 manufactured by Pelco, Inc. The camera may be located in a center of the beam 24. Preferably, the camera 16 is enclosed in a waterproof casing. It may also be equipped with an external automatic lens wiper to keep water and dust off of the lens of the camera. In a preferred embodiment, the camera has a 0×150 zoom function and auto focus capability. In addition, the camera may be controlled so that the plant operator can direct the camera in different directions via a joystick control box located in the plant station.

In an alternative embodiment of the present invention, the plant operator may control the washing function via the nozzles 20 with a manual or remote control of the valve 32 based on a visual inspection of the location of the truck 10. In that case, the photo cell 38 is not necessary. In such an operation, the plant operator is located sufficiently close to the station 14 so that the plant operator can see when the truck 10 approaches the station 14.

Although various control options are possible, in a preferred embodiment, the plant operator station is equipped with a control box for controlling the entire system. Specifically, the plant operator station includes means for manually or automatically turning on and off the flood light 28 and the camera 16. In addition, the plant operator station may also include means for adjusting a zoom of the camera 16, a wiper for the camera 16, and for controlling the direction in which the camera 16 is pointed.

In addition, the plant operator station includes means for controlling the discharge of water from the nozzle 18. Such control may be accomplished by simply turning on and off a valve enabling water to flow from the nozzle 18. Or, in a more sophisticated system, the operator can merely program in a quantity of water to be emitted into the mixing drum of the truck 10, and an automated control system automatically controls a valve so as to ensure that the programmed quantity of water is pumped into the mixing drum through the nozzle 18.

The plant operator station may also include controls for controlling the valve 32 which turns on and off the flow of water through the nozzles 20. As set forth above, such control can be accomplished manually or automatically, with use of the photo cell 38.

All of the aforesaid control systems are constructed based on known technology in accordance with means known to those of ordinary skill in the art. Accordingly, additional details concerning the manual and/or automatic controls are omitted.

It should also be readily apparent to those of ordinary skill in the art that the system described herein does not need to have both the washing system and the slump filling system in combination as disclosed. Specifically, the washing system can be at a separate station from the slump filling station, or can be completely omitted. Or, in an alternative embodiment, the washing system can be used by itself, i.e., without the slump adjusting system.

Although only preferred embodiments are specifically illustrated and described herein, it will be appreciated that many modifications and variations of the present invention are possible in light of the above teachings and within the purview of the appended claims without departing from the spirit and intended scope of the invention.

1. A system for loading a mixing truck with concrete with a proper slump, the system comprising:
a conduit for depositing concrete into the mixing truck;
a camera for viewing the mixing truck;
a monitor for monitoring the camera;
a water pipe for depositing water into the mixing truck; and
a control panel for controlling the depositing of water into the truck, the control panel being adjacent the monitor.

2. The system of claim 1, wherein the monitor is at a location remote from the mixing truck.

3. The system of claim 2, further comprising a plurality of nozzles arranged for washing an exterior of the mixing truck.

4. The system of claim 2, further comprising a frame having an opening through which the mixing truck can pass, the water pipe and the camera being mounted on the frame.

5. The system of claim 3, further comprising a frame having an opening through which the mixing truck can pass, the water pipe, the camera, and the plurality of nozzles are mounted on the frame.

6. The system of claim 5, further comprising a signal post including a plurality of signals for providing instructions to a driver of the mixing truck, the signals being controlled by a controller adjacent the monitor.

7. The system of claim 3, further comprising a detector for detecting a presence of the mixing truck and the detector is used to automatically turn on and off the plurality of nozzles for washing the truck.

8. The system of claim 1, wherein the camera is arranged to view the concrete inside a mixing drum of the mixing truck.

9. The system of claim 1, further comprising a slump gage mounted on an exterior portion of the mixing truck.

10. The system of claim 9, wherein the camera is arranged to view the slump gage.

11. The system of claim 8, further comprising a controller for controlling a position of the camera, wherein the position of the camera can be controlled from a location adjacent the monitor.

12. The system of claim 10, further comprising a controller for controlling a position of the camera, wherein the position of the camera can be controlled from a location adjacent the monitor.

13. A system for loading a mixing truck with concrete and adjusting a proper slump of the concrete, the system comprising:
a conduit for depositing concrete into a mixing drum of the mixing truck;
a frame having an opening through which the mixing truck can pass;
a camera mounted on the frame for viewing the mixing truck;
a monitor for monitoring the camera, wherein the monitor is at a location remote from the mixing truck;
a water pipe mounted on the frame for depositing water into the mixing drum of the mixing truck;
a control panel for controlling the depositing of water into the mixing drum, the control panel being adjacent the monitor; and
a plurality of nozzles mounted on the frame and arranged for washing an exterior of the mixing truck.

14. The system of claim 13, further comprising a signal post including a plurality of signals for providing instructions to a driver of the mixing truck, the signals being controlled by a controller adjacent the monitor.

15. The system of claim 13, further comprising a detector for detecting a presence of the mixing truck and the detector is used to automatically turn on and off the plurality of nozzles for washing the truck.

16. The system of claim 13, further comprising a controller for controlling a position of the camera, wherein the position of the camera can be controlled from a location adjacent the monitor.

17. A system for adjusting a slump in a mixing drum of a mixing truck loaded with concrete, the system comprising:
a camera mounted for viewing the mixing truck;
a monitor for monitoring the camera, wherein the monitor is at a location remote from the mixing truck;
a water pipe for depositing water into the mixing drum; and
a control panel for controlling the depositing of water into the mixing drum, the control panel being adjacent the monitor.

18. The system of claim 17, further comprising a plurality of nozzles arranged for washing an exterior of the mixing truck.

19. The system of claim 18, further comprising a frame having an opening through which the mixing truck can pass, the water pipe, the camera, and the plurality of nozzles are mounted on the frame.

20. The system of claim 17, further comprising a signal post including a plurality of signals for providing instructions to a driver of the mixing truck, the signals being controlled by a controller adjacent the monitor.

21. The system of claim 19, further comprising a detector for detecting a presence of the mixing truck and the detector is used to automatically turn on and off the plurality of nozzles for washing the truck.

22. The system of claim 17, wherein the camera is arranged to view the concrete inside the mixing drum.

23. The system of claim 17, further comprising a slump gage mounted on an exterior portion of the mixing truck.

24. The system of claim 23, wherein the camera is arranged to view the slump gage.

25. A method for adjusting a slump in a mixing truck, the method comprising:
moving the mixing truck which is loaded with concrete to a slump adjusting station;
viewing the mixing truck with a camera mounted on the frame from a remote location; and
depositing water into a mixing drum of the mixing truck with a water pipe located at the slump adjusting station;
whereby the depositing step is controlled from the remote location so that the slump of the concrete can be controlled from the remote location.

26. The method of claim 25, wherein the slump adjusting station further includes a plurality of nozzles for washing an exterior of the truck and the truck is washed at the slump adjusting station.

27. The method of claim 26, wherein the plurality of nozzles are controlled from the remote location.

28. The method of claim 26, wherein the plurality of nozzles are controlled by a sensor which detects the presence of a mixing truck at the slump adjusting station.
